(19) United States
(12) Patent Application Publication
(10) Pub. No.: US 2011/0209916 A1
(43) Pub. Date: Sep. 1, 2011

(54) SHEATHED WIRE, SHEATHED WIRE WITH TERMINAL, AND METHOD FOR PRODUCING SHEATHED WIRE WITH TERMINAL

(75) Inventors: Shuji Iwamoto, Tokyo (JP); Fumio Yajima, Tokyo (JP); Yumiko Tanaka, Tokyo (JP); Yoshiaki Saito, Tokyo (JP); Yoshiaki Ishikawa, Yamagata (JP); Katsuyuki Numazawa, Yamagata (JP)

(73) Assignees: FUJIKURA LTD., Tokyo (JP); YONEZAWA ELECTRIC WIRE CO., LTD., Yonezawa-shi, Yamagata (JP)

(21) Appl. No.: 13/057,880

(22) PCT Filed: Aug. 7, 2009
(86) PCT No.: PCT/JP2009/064064

§ 371 Date: May 2, 2011

(30) Foreign Application Priority Data
Aug. 8, 2008 (JP) 2008-206387

(51) Int. Cl. H02G 15/02; H01B 7/00; H02G 1/00

(52) U.S. Cl. 174/74 R; 174/120 R; 29/857

(57) ABSTRACT

Provided are a sheathed wire that can be processed without being covered with a protective material, a sheathed wire with a terminal, and a method of producing a sheathed wire with a terminal. In a sheathed wire (10) including: a core (16) made of a conductor (12) covered with an insulator (14); and a sheath (18) covering the circumferential surface of the core (16), at least a part of the sheath (18) is provided slidably with respect to the core (16) in the axial direction of the core (16), and the slidable part of the sheath (18) has a slit (20) from the outer surface thereof to the inner surface thereof in a manner that the slit (20) extends in the axial direction.

### TECHNICAL FIELD

The present invention relates to a sheathed wire including: a core made of a conductor covered with an insulator; and a sheath covering the circumferential surface of the core, a sheathed wire with a terminal, and a method of producing a sheathed wire with a terminal

### BACKGROUND ART

Conventionally, a sheathed wire has been used for a wire of an automobile, etc. For example, the subject matter described in Patent Document 1 is proposed for facilitating processing of a sheathed wire. As shown in FIG. 11, the sheathed wire 30 described in Patent Document 1 includes cores 36 each made of a conductor 32 covered with an insulator 34 and a sheath 38 covering the circumferential surface of the cores 36. The sheath 38 is slidable with respect to the cores 36 with a loose contact between the cores 36 and the sheath 38.

The sheathed wire described in Patent Document 1 has a loose contact between the cores and the sheath so that the sheath can slide with respect to the cores. Therefore, when processing an end portion or a middle portion of the sheathed wire, it is possible to process the end portion or the middle portion by sliding the sheath on the cores. Therefore, it becomes possible to reduce the range of the sheath that is to be processed as compared with a conventional sheathed wire, and hence to reduce the range of the cores that is exposed and should be covered with a protective material, which leads to a cost reduction.

### Conventional Art Document

### Patent Document

Patent Document 1: JP2004-63215A

### DISCLOSURE OF INVENTION

### Problem to be Solved by the Invention

However, although the exposed portion of the cores that should be covered is reduced, the sheathed wire described in Patent Document 1 does require such a portion to be covered with a protective material. Therefore, there is a problem that the process time and cost cannot be reduced sufficiently.

Hence, the present invention aims for providing a sheathed wire that can be processed without being covered with a protective material, a sheathed wire with a terminal, and a method of producing a sheathed wire with a terminal

### Means for Solving the Problem

To achieve the above object, the present invention provides a sheathed wire comprising: a core made of a conductor covered with an insulator; and a sheath covering a circumferential surface of the core, wherein at least a part of the sheath is slidable with respect to the core in an axial direction of the core, and the sheath has a slit that is formed in the slidable part from an outer surface of the slidable part to an inner surface thereof and that extends in the axial direction.

In the sheathed wire according to the present invention, the sheath may be formed capable of narrowing a distance between both axial-direction end portions of the sheath by allowing the slidable part to be slid in a manner to open the slit. Alternatively, a whole of the sheath may be slidable with respect to the core in the axial direction, and the slit may be formed along a longer direction of the sheath from at least one end portion of the sheath.

In the sheathed wire according to the present invention, the slit may be formed in pair, and the pair of slits may be located at positions at which they face each other. In this case, the core may be provided in pair, and the pair of slits may be located between the pair of cores to face each other.

The present invention also provides a sheathed wire with a terminal, obtained by fitting a terminal on the conductor at an end portion of the sheathed wire described above.

A first embodiment of a method of producing a sheathed wire with a terminal according to the present invention comprises: a sliding step of sliding the slidable part of the sheathed wire described above in a manner to open the slit to narrow a distance between both axial-direction end portions of the sheath; and a terminal fitting step of fitting a terminal on an end portion of the core that is on a side where the circumferential surface of the core is exposed as a result of the sliding step. The method of producing a sheathed wire with a terminal may comprise: a slit forming step of forming a slit in a sheath of a sheathed wire including a core made of a conductor covered with an insulator and the sheath covering a circumferential surface of the core, wherein at least a part of the sheath is slidable with respect to the core in an axial direction of the core, and the slit is formed in the slidable part of the sheath from an outer surface of the slidable part to an inner surface thereof in a manner that the slit extends in the axial direction; a sliding step of sliding the slidable part of the sheathed wire in a manner to open the slit to narrow a distance between both axial-direction end portions of the sheath; and a terminal fitting step of fitting a terminal on an end portion of the core that is on a side where the circumferential surface of the core is exposed as a result of the sliding step. The method of producing a sheathed wire with a terminal according to the first embodiment may further comprise a restoring step of restoring the sheath to its state before the sliding step, by sliding the slidable part in a manner to close the slit.

A second embodiment of a method of producing a sheathed wire with a terminal according to the present invention comprises: a sliding step of sliding a whole of the sheath of the sheathed wire described above to a position at which there is located a base end of a terminal to be fitted on an end portion of the core that is on a side where the slit is formed, wherein the sheathed wire has the whole of the sheath provided slidable with respect to the core in the axial direction and has the slit formed along a longer direction of the sheath from one end portion of the sheath; a core drawing-out step of drawing out the core along the slit to expose the circumferential surface of the core from the sheath; and a terminal fitting step of fitting a terminal on the end portion of the core that is exposed as a result of the core drawing-out step. The method of producing a sheathed wire with a terminal may comprise: a slit forming step of forming a slit in a sheath of a sheathed wire including a core made of a conductor covered with an insulator and the sheath covering a circumferential surface of the core, wherein a whole of the sheath is slidable with respect to the core in an axial direction of the core, and the slit is formed along a longer direction of the sheath from one end portion of the sheath from an outer surface of the sheath to an inner surface thereof; a sliding step of sliding the whole of the sheath to a position at which there is located a base end of a terminal to be fitted on an end portion of the core that is on a side where the slit is formed; a core drawing-out step of drawing out the core along the slit to expose the circumferential surface of the core from the sheath; and a terminal fitting step of fitting a terminal on the end portion of the core that is exposed as a result of the core drawing-out step. The method of producing a sheathed wire with a terminal according to the second embodiment may further comprise a restoring step of restoring the sheath and the core to their state before the core drawing-out step, by placing back an exposed portion of the core into the sheath and closing the slit.

In the method of producing a sheathed wire with a terminal according to the second embodiment, the sliding step may be performed after the core drawing-out step or after the terminal fitting step though it is preferable that the sliding step be performed before the core drawing-out step,.

The method of producing a sheathed wire with a terminal according to the second embodiment may further comprise, as preparatory steps: a sheath removing step of cutting the sheath along its entire circumference at a certain position as measured from an end portion of the sheath on a side where the slit is not formed, for example, a position that is at a length of about double a length of the conductor necessary for fitting a terminal and removing the sheath from the cut position, and a terminal fitting step of fitting a terminal on an end portion of the core that is exposed as a result of the sheath removing step.

The first and second embodiments of the method of producing a sheathed wire with a terminal according to the present invention may further comprise a sealing step of applying a sealing process to the slit after the restoring step to maintain the slit in a sealed state. This removes the possibility of the core sticking out of the sheath and improves work efficiency.

### Effect of the Invention

As described above, according to the present invention, it is possible to provide a sheathed wire that can be processed without being covered with a protective material, a sheathed wire with a terminal, and a method of producing a sheathed wire with a terminal.

### BRIEF DESCRIPTION OF THE DRAWINGS

FIG. 1 is a plan diagram of a first example of a sheathed wire according to the present invention.

FIG. 2 is a cross-sectional diagram of FIG. 1 taken along a line A-A′.

FIG. 3 are process charts showing a method of producing a sheathed wire with a terminal according to the first example.

FIG. 4 is a plan diagram of a second example of the sheathed wire according to the present invention.

FIG. 5 are process charts showing a method of producing a sheathed wire with a terminal according to the second example.

FIG. 6 is a plan diagram of a third example of the sheathed wire according to the present invention.

FIG. 7 are process charts showing a method of producing a sheathed wire with a terminal according to the third example.

FIG. 8 is a cross-sectional diagram showing a state that heat generating members are placed on the sheathed wire with a terminal according to the first example and the second example.

FIG. 9 is a plan diagram showing a state that a slit of the sheathed wire with a terminal according to the first example to the third example is sealed by a label.

FIG. 10 is a plan diagram showing a state that a slit of the sheathed wire with a terminal according to the first example to the third example is sealed by a tape.

FIG. 11 is a partial plan diagram of a conventional sheathed wire.

### BEST MODE FOR CARRYING OUT THE INVENTION

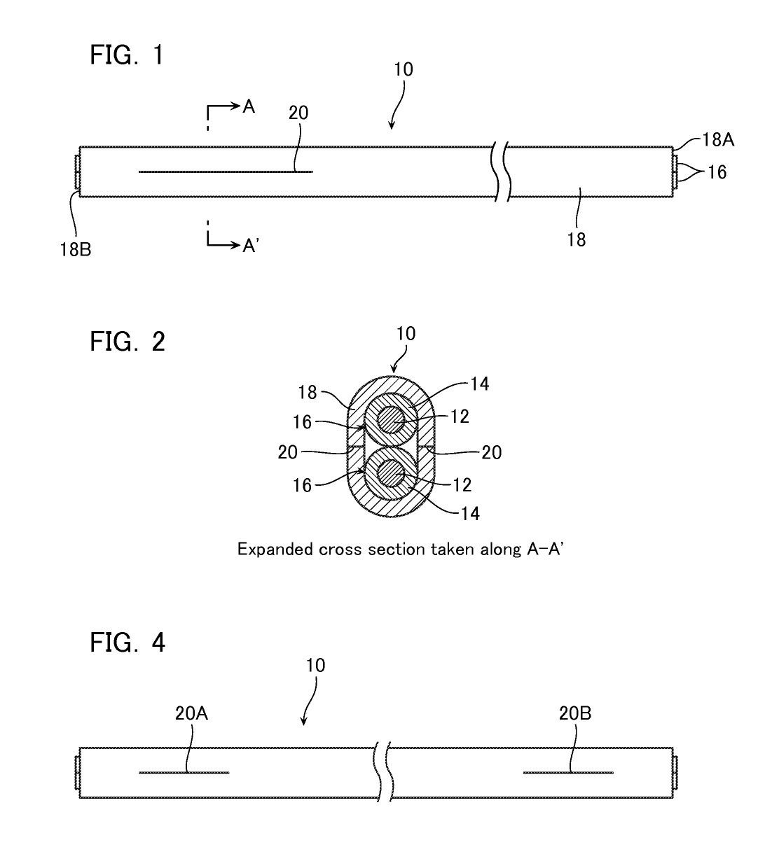

Next, a first example of a sheathed wire according to the present invention will be explained with reference to the drawings. FIG. 1 is a front elevation of a sheathed wire according to the first example. FIG. 2 is a cross-sectional diagram of FIG. 1 taken along a line A-A′. As shown in FIG. 1 and FIG. 2, a sheathed wire 10 according to the first example includes: a pair of cores 16 and 16 each made of a conductor 12 covered with an insulator 14; and a sheath 18 covering the circumferential surface of the cores 16 and 16 arranged in parallel. The sheath 18 is provided mainly for the purpose of mechanical protection. The sizes and materials of the sheathed wire 10 according to the first embodiment will be described in detail. The two cores 16 each having a nominal size of 0.5 mm² and a finished outer diameter of 1.55 mm are placed in parallel with each other, and covered with the sheath 18 continuously extruded thereonto and having a thickness of 0.8 mm, whereby the sheathed wire 10 which on the whole has a longer diameter of 4.8 mm and a shorter diameter of 3.2 mm is formed. The materials of the insulator 14 and the sheath 18 are both styrene thermoplastic elastomers. However, in the sheathed wire according to the present invention, the sizes and materials of the sheathed wire 10 are not limited to those described above, but the sheathed wire may have an ellipsoidal cross-sectional shape.

In the sheathed wire 10 according to the first example, the sheath 18 is slidable with respect to the cores 16. In this case, when forming the sheath 18 on the outer circumference of the cores 16 by continuous extrusion of a resin, a loose contact is provided between the cores 16 and the sheath 18. The method for providing a loose contact between the cores 16 and the sheath 18 includes a method of setting the temperature of the sheath material resin when extruding it onto the outer circumference of the cores 16 to a temperature near the lower limit of the temperature range in which the resin can be extruded (when the insulator 14 and the sheath 18 are styrene thermoplastic elastomers, the temperature near the lower limit is, for example 200° C.). Another method quenches the covering resin (sheath) immediately after it is extruded onto the outer circumference of the cores 16. Still another method provides a loose contact between the cores and the sheath by improving the extrusion head of the extruder. Specific methods are described in Patent Document 1.

By producing the sheathed wire 10 by such a method, it was possible to suppress the force necessary for pulling the sheath 18 away from the cores 16 in the sheathed wire 10 having a length of, for example, 1 m to a maximum of about 0.5 kgf. This force is not only certainly lower than the breaking load value of the cores 16, but also such a small force that can slide the sheath 18 easily and pull it away from the cores 16 without tearing it.

In the sheathed wire 10 according to the first example, a pair of slits 20 and 20 are formed between the axial direction center of the sheath 18 and the left-hand end thereof from the outer surface of the sheath 18 to the inner surface thereof in a manner that the slits 20 and 20 extend in the axial direction. The pair of slits 20 and 20 are located between the pair of cores 16 to face each other. The pair of slits 20 and 20 can be formed by forming cutouts by a cutter, etc.

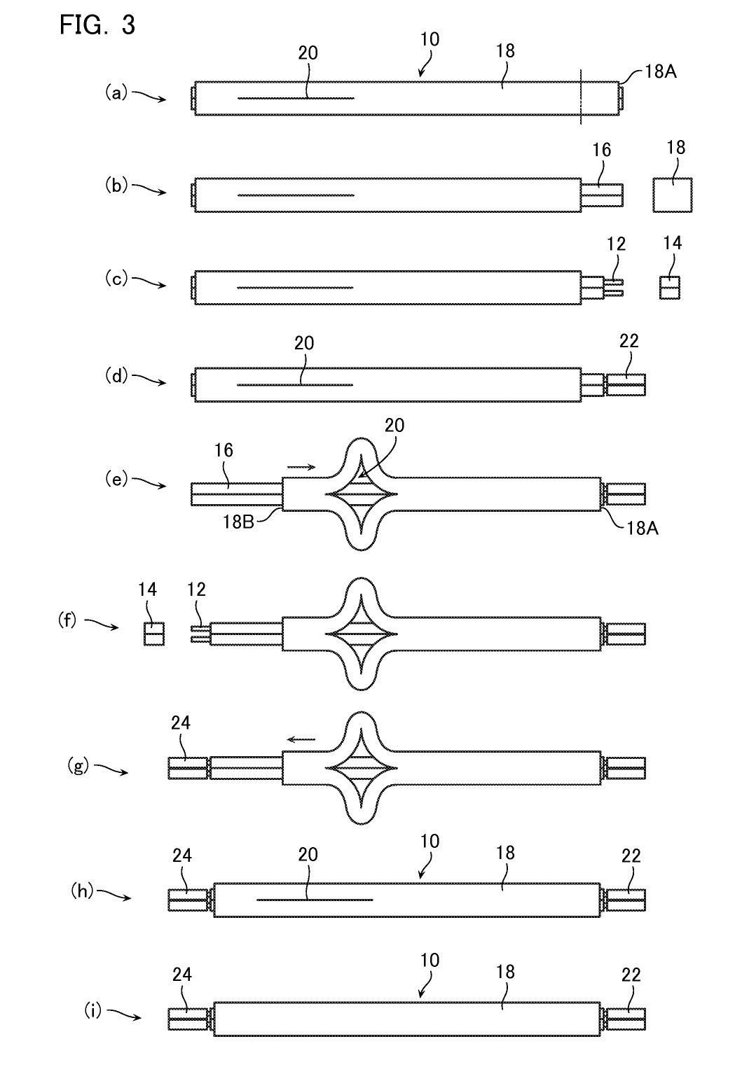

Next, a method of processing the sheathed wire 10 and a method of producing a sheathed wire with a terminal according to the first example will be explained with reference to FIG. 3. First, the sheath 18 of the sheathed wire 10 is cut along its entire circumference at a position that is at a length of about double a length of the conductor 12 necessary for fitting a terminal as measured from a right-hand end portion 18A (FIG. 3(a)), and the cores 16 are exposed by removing the cut portion of the sheath 18 (FIG. 3(b)). Next, the insulator 14 of the exposed cores 16 is removed by the length of the conductor necessary for fitting a terminal, to expose the conductor 12 (FIG. 3(c)), and then a terminal 22 is fitted on the conductor 12 (FIG. 3(d)). Next, the sheath 18 is slid toward the base end of the terminal 22, i.e., rightward in the axial direction and the slits 20 are opened to thereby bring a left-hand end portion 18B of the sheath 18 close to the right-hand end portion 18A and narrow the distance between both the end portions to expose the cores 16 (FIG. 3(e)). Next, the insulator 14 of the exposed cores 16 is removed by a length of the conductor necessary for fitting a terminal to expose the conductor 12 (FIG. 3(f)), then a terminal 24 is fitted on the conductor 12 (FIG. 3(g)), and then the left-hand end portion 18B of the sheath 18 is slid in a manner to close the slits 20 to restore the original state (FIG. 3(h)). Finally, a pair of heat generating members 26 are placed to abut at least the portions of the sheath 18 where the slits 20 are formed in a manner to sandwich the portions as shown in FIG. 8, and heat is applied to the portions where the slits 20 are formed to melt the sheath 18 to bond the slits 20 and maintain a sealed state (FIG. 3(i)).

Next, a second example of the sheathed wire according to the present invention will be explained with reference to the drawings. FIG. 4 is a front elevation of a sheathed wire according to the second example. Unlike the first example, a sheathed wire 10 according to the second example has slits 20A and 20B formed between its axial direction center and both its left-hand and right-hand end portions respectively. The portions of the sheath 18 where the slits 20A and 20B are located can slide with respect to the cores 16 with a loose contact between the cores 16 and the sheath 18, while the portion between the slits 20A and 20B cannot slide or can hardly slide with no loose contact.

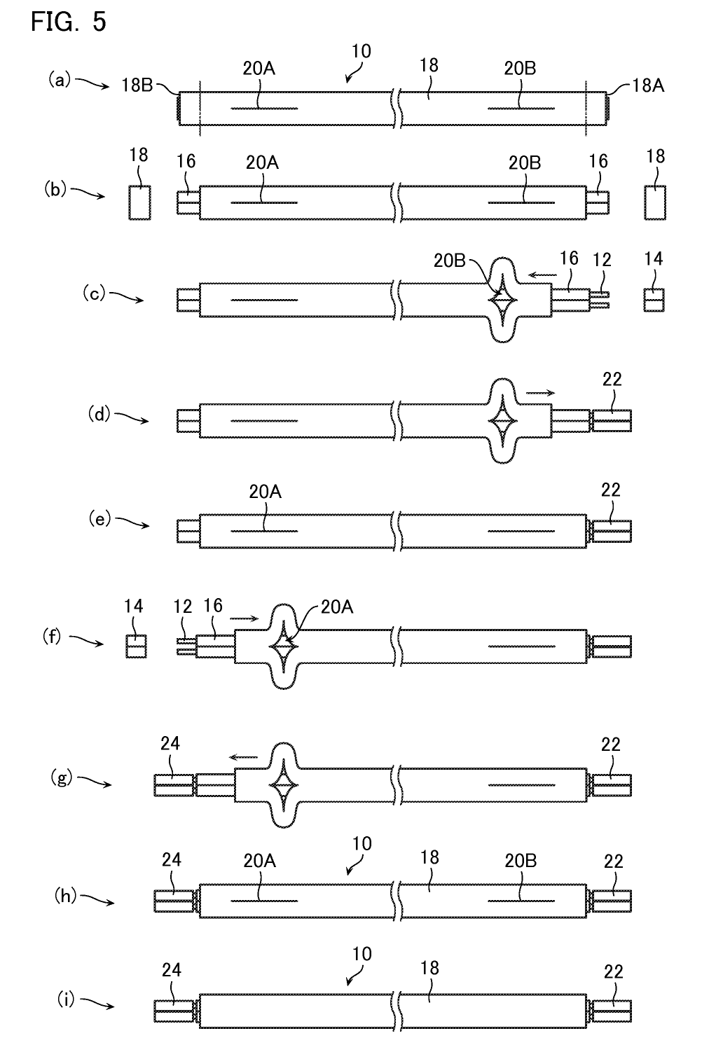

Next, a method of processing the sheathed wire 10 and a method of producing a sheathed wire with a terminal according to the second example will be explained with reference to FIG. 5. First, the sheath 18 of the sheathed wire 10 is cut along its entire circumference at positions that are at a length of the conductor 12 necessary for fitting a terminal as measured from both the right-hand and left-hand end portions 18A and 18B respectively (FIG. 5(a)), and the cores 16 are exposed by removing the cut portions of the sheath 18 (FIG. 5(b)). Next, the slits 20B are opened and the right-hand end portion 18A of the sheath 18 is slid leftward in the axial direction to be brought close to the left-hand end portion 18B to thereby expose the cores 16, and then the insulator 14 is removed from the end portion of the exposed cores 16 by the length of the conductor necessary for fitting a terminal to expose the conductor 12 (FIG. 5(c)). Then, a terminal 22 is fitted on the conductor 12 (FIG. 5(d)), and the right-hand end portion 18A of the sheath 18 is slid rightward in the axial direction in a manner to close the slits 20B (FIG. 5(e)). Next, the slits 20A are opened and the left-hand end portion 18B of the sheath 18 is slid rightward in the axial direction to be brought close to the right-hand end portion 18A to thereby expose the cores 16, and then the insulator 14 is removed from the end portion of the exposed cores 16 by the length of the conductor necessary for fitting a terminal to expose the conductor 12 (FIG. 5(f)). Then, a terminal 24 is fitted on the conductor 12 (FIG. 5(g)), and the left-hand end portion 18B of the sheath 18 is slid leftward in the axial direction in a manner to close the slits 20A and restore the original state (FIG. 5(h)). Finally, a pair of heat generating members 26 are placed to abut at least the portions of the sheath 18 where the slits 20 are formed to sandwich the portions as shown in FIG. 8, and heat is applied to the portion where the slits 20 are formed to melt the sheath 18 to bond the slits 20 and maintain a sealed state (FIG. 5(i)).

Also when forming the sheath slidable over the whole axial direction range of the cores 16 as in the sheathed wire 10 according to the first example, it is possible to carry out the method of processing the sheathed wire 10 and the method of producing a sheathed wire with a terminal by the same steps as used in the second example based on FIG. 5.

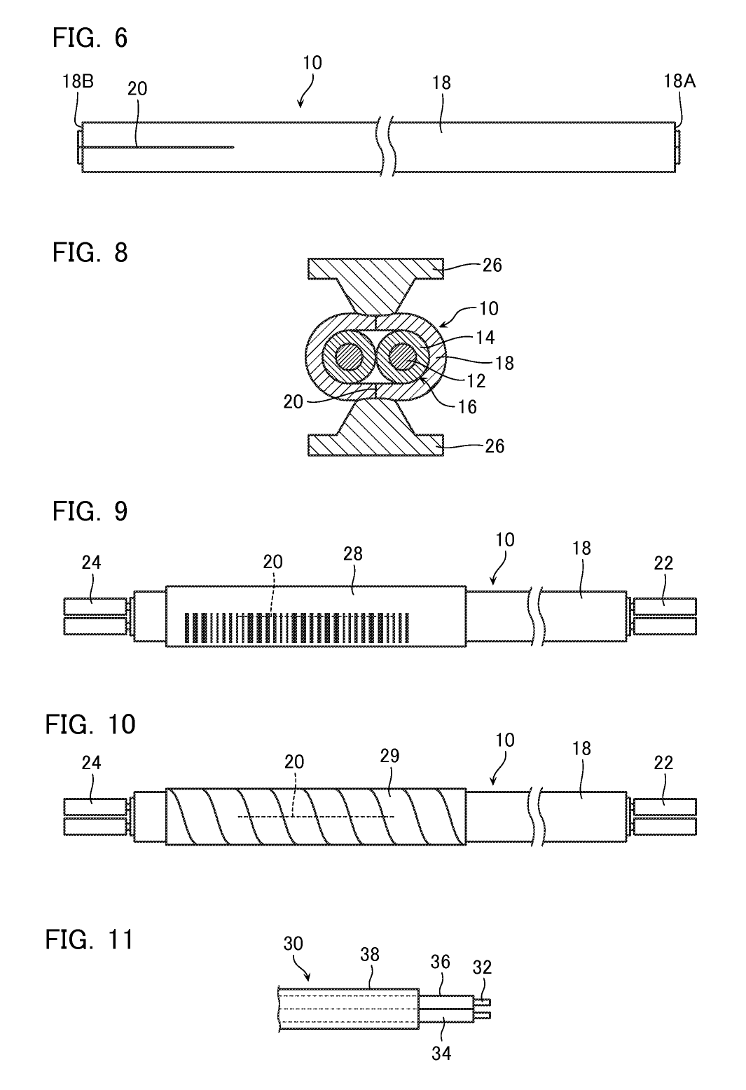

Next, a third example of the sheathed wire according to the present invention will be explained with reference to the drawings. FIG. 6 is a front elevation of a sheathed wire according to the third example. Unlike the first example, the sheathed wire 10 according to the third example has slits 20 formed along the longer direction from the left-hand end portion 18B of the sheath 18. The whole of the sheath 18 can slide with respect to the cores 16 in the axial direction.

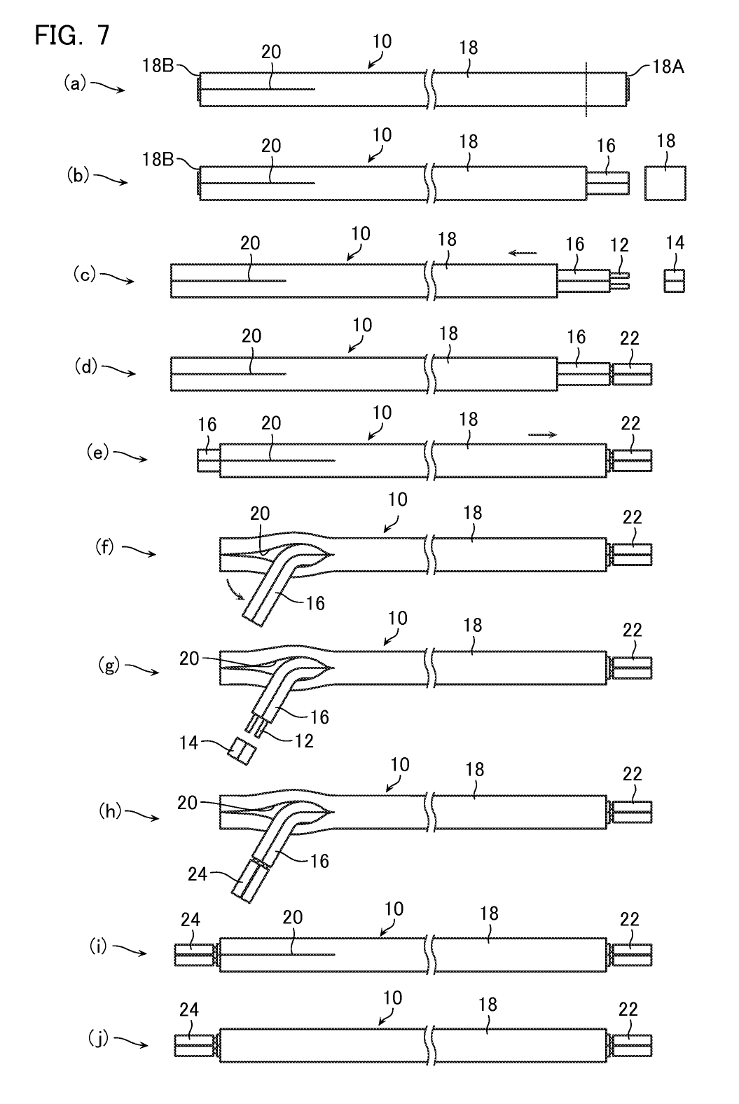

Next, a method of processing the sheathed wire 10 and a method of producing a sheathed wire with a terminal according to the third example will be explained with reference to FIG. 7. First, the sheath 18 of the sheathed wire 10 is cut along its entire circumference at a position that is at a length of about double a length of the conductor 12 necessary for fitting a terminal as measured from the right-hand end portion 18A (FIG. 7(a)), then the cores 16 are exposed by removing the cut portion of the sheath 18 (FIG. 7(b)), and then the sheath 18 is slid toward the end portion where the slits 20 are formed, i.e., leftward in the axial direction. Next, the insulator 14 is removed from the end portion of the exposed cores 16 by the length of the conductor 12 necessary for fitting a terminal to expose the conductor 12 (FIG. 7(c)), and a terminal 22 is fitted on the conductor 12 (FIG. 7(d)). Next, the sheath 18 is slid toward the position at which the base end of the terminal 22 is located, i.e., rightward in the axial direction (FIG. 7(e)), and the cores 16 on the side where the slits 20 are formed, i.e., on the left-hand end portion side are drawn out along the slit 20 of the sheath 18 to be exposed from the sheath 18 (FIG. 7(f)). Next, the insulator 14 is removed from the end portion of the exposed cores 16 by the length of the conductor necessary for fitting a terminal to expose the conductor 12 (FIG. 7(g)), a terminal 24 is fitted on the conductor 12 (FIG. 7(h)), and the exposed cores 16 are placed back into the sheath 18 to restore the original state (FIG. 7(i)). Finally, like in the first example and the second example, the heat generating members 26 are placed to abut at least the portions of the sheath 18 where the slits 20 are formed, and heat is applied to the portions where the slits 20 are formed to melt the sheath 18 to bond the slits 20 and maintain a sealed state (FIG. 7(j)).

When attaching the terminals 22 and 24 fitted on the sheathed wire 10 according to the third example to connectors, etc., it is possible to add a step of sliding the sheath 18 toward its end portion where the slits 20 are formed, i.e., leftward in the axial direction and attaching a connector to the terminal 22 fitted on the cores 16, and after this, a step of sliding the sheath 18 toward the position at which the base end of the terminal 22 is located, i.e., rightward in the axial direction to return the sheath 18 to the original position and attaching a connector to the terminal 24 fitted on the cores 16, between the step of fitting the terminal 24 on the sheathed wire 10 (FIG. 7(h)) and the step of placing back the exposed cores 16 into the sheath 18 (FIG. 7(i)).

In the sheathed wire 10 according to the third example, the slits 20 to be formed in the sheath 18 may be formed when the sheath 18 is slid with respect to the cores 16 in the axial direction such that the left-hand end portion 18B of the sheath 18 is protruded from the left-hand end portion of the cores 16. This makes it possible to form the slits 20 in the sheath 18 without damaging the cores 16.

It has been explained that when fitting the terminal 24 on the sheathed wire 10 according to the third example, the sheath 18 is slid toward the position at which the base end of the terminal 22 is located, i.e., rightward in the axial direction, and after this the cores 16 are drawn out and exposed along the slit 20 of the sheath 18 to be fitted with the terminal 24. However, it may be after the cores 16 are drawn out and exposed from the slit 20 of the sheath 18 or after the terminal 24 is fitted that the sheath 18 is slid toward the position at which the base end of the terminal 22 is located, i.e., rightward in the axial direction.

In the first to third examples described above, the case has been fitting terminals to the end portions of the wire. However, for example, the middle portion of the sheath may be cut and a terminal may be fitted to this portion.

The number and position of the slits to be formed in the sheath 18 are not limited to those in the first to third examples, but may be changed appropriately.

It has also been explained that heat applied to the slits 20, 20A, and 20B by the heat generating members 26 bonds the sheath 18 and maintains it in the sealed state. However, this is not limiting. For example, it is also possible to seal the openings at the slits and maintain the sealed state by attaching a label 28 or a tape 29 having tackiness in a manner to cover the slits 20, 20A, and 20B of the sheath 18, as shown in FIG. 8 and FIG. 9.

### DESCRIPTION OF REFERENCE NUMERALS

10 sheathed wire
12 conductor
14 insulator
16 core
18 sheath
20 slit
22, 24 terminal
26 heat generating member

1. A sheathed wire comprising: a core made of a conductor covered with an insulator; and a sheath covering a circumferential surface of the core,
wherein at least a part of the sheath is slidable with respect to the core in an axial direction of the core, and
the sheath has a slit that is formed in the slidable part from an outer surface of the slidable part to an inner surface thereof.

2. The sheathed wire according to claim 1,
wherein the sheath is formed capable of narrowing a distance between both axial-direction end portions of the sheath by allowing the slidable part to be slid in a manner to open the slit.

3. The sheathed wire according to claim 1,
wherein a whole of the sheath is slidable with respect to the core in the axial direction, and
the slit is formed along a longer direction of the sheath from at least one end portion of the sheath.

4. The sheathed wire according to claim 1,
wherein the slit is formed in pair, and the pair of slits are located at positions at which they face each other.

5. The sheathed wire according to claim 4,
wherein the core is provided in pair, and
the pair of slits are located between the pair of cores to face each other.

6. A sheathed wire with a terminal, obtained by fitting a terminal on the conductor at an end portion of the sheathed wire according to claim 1.

7. A method of producing a sheathed wire with a terminal, comprising:
a sliding step of sliding the slidable part of the sheathed wire according to claim 1 in a manner to open the slit to narrow a distance between both axial-direction end portions of the sheath; and
a terminal fitting step of fitting a terminal on an end portion of the core that is on a side where the circumferential surface of the core is exposed as a result of the sliding step.

8. A method of producing a sheathed wire with a terminal, comprising:
a slit forming step of forming a slit in a sheath of a sheathed wire including: a core made of a conductor covered with an insulator; and the sheath covering a circumferential surface of the core, at least a part of the sheath being slidable with respect to the core in an axial direction of the core, the slit being formed in the slidable part of the sheath from an outer surface of the slidable part to an inner surface thereof in a manner that the slit extends in the axial direction;
a sliding step of sliding the slidable part of the sheathed wire in a manner to open the slit to narrow a distance between both axial-direction end portions of the sheath; and
a terminal fitting step of fitting a terminal on an end portion of the core that is on a side where the circumferential surface of the core is exposed as a result of the sliding step.

9. The method of producing a sheathed wire with a terminal according to claim 7, further comprising a restoring step of restoring the sheath to its state before the sliding step, by sliding the slidable part in a manner to close the slit.

10-13. (canceled)

14. The method of producing a sheathed wire with a terminal according to claim 8, further comprising a restoring step of restoring the sheath to its state before the sliding step, by sliding the slidable part in a manner to close the slit.

15. A method of producing a sheathed wire with a terminal, comprising:
a sliding step of sliding a whole of the sheath of the sheathed wire according to claim 1 to a position at which there is located a base end of a terminal to be fitted on an end portion of the core that is on a side where the slit is formed, wherein in the sheathed wire according to claim 1, the whole of the sheath is provided slidable with respect to the core in the axial direction, and the slit is formed along a longer direction of the sheath from one end portion of the sheath;
a core drawing-out step of drawing out the core along the slit to expose the circumferential surface of the core from the sheath; and
a terminal fitting step of fitting a terminal on the end portion of the core that is exposed as a result of the core drawing-out step.

16. A method of producing a sheathed wire with a terminal, comprising:
a slit forming step of forming a slit in a sheath of a sheathed wire including: a core made of a conductor covered with an insulator; and the sheath covering a circumferential surface of the core, a whole of the sheath being slidable with respect to the core in an axial direction of the core, the slit being formed along a longer direction of the sheath from one end portion of the sheath from an outer surface of the sheath to an inner surface thereof;
a sliding step of sliding the whole of the sheath to a position at which there is located a base end of a terminal to be fitted on an end portion of the core that is on a side where the slit is formed;
a core drawing-out step of drawing out the core along the slit to expose the circumferential surface of the core from the sheath; and
a terminal fitting step of fitting a terminal on the end portion of the core that is exposed as a result of the core drawing-out step.

17. The method of producing a sheathed wire with a terminal according to claim 15, further comprising a restoring step of restoring the sheath and the core to their state before the core drawing-out step, by placing back an exposed portion of the core into the sheath and closing the slit.

18. The method of producing a sheathed wire with a terminal according to claim 16, further comprising a restoring step of restoring the sheath and the core to their state before the core drawing-out step, by placing back an exposed portion of the core into the sheath and closing the slit.

19. The method of producing a sheathed wire with a terminal according to claim 7, further comprising a sealing step of applying a sealing process to the slit after the restoring step to maintain the slit in a sealed state.

20. The method of producing a sheathed wire with a terminal according to claim 8, further comprising a sealing step of applying a sealing process to the slit after the restoring step to maintain the slit in a sealed state.

21. The method of producing a sheathed wire with a terminal according to claim 15, further comprising a sealing step of applying a sealing process to the slit after the restoring step to maintain the slit in a sealed state.

22. The method of producing a sheathed wire with a terminal according to claim 16, further comprising a sealing step of applying a sealing process to the slit after the restoring step to maintain the slit in a sealed state.
